(19) United States
(12) Patent Application Publication
(10) Pub. No.: US 2010/0033099 A1
(43) Pub. Date: Feb. 11, 2010

(54) THREE-LEVEL DIMMING CIRCUIT FOR DISCHARGING LAMP

(75) Inventor: Chao-Chin Yeh, Changhwa County (TW)

Correspondence Address: BROWDY AND NEIMARK, P.L.L.C.;624 NINTH STREET, NW, SUITE 300, WASHINGTON, DC, 20001-5303, US

(73) Assignee: CHUAN SHIH INDUSTRIAL CO., LTD, TIEN CHUNG TOWNSHIP (TW)

(21) Appl. No.: 12/200,099

(22) Filed: Aug. 28, 2008

(30) Foreign Application Priority Data
Aug. 8, 2008 (TW) 97130450

(51) Int. Cl. H05B 41/14

(52) U.S. Cl. 315/205

(57) ABSTRACT

A three-level dimming circuit for a discharging lamp includes a first contact, a second contact, and a third contact, a first full-wave rectification circuit connected to the first contact and the third contact, and a second full-wave rectification circuit connected to the first contact and the second contact. A selection circuit includes three resistors and a first electrical controlled switch. A half-wave rectification circuit includes a second electrical controlled switch and a third electrical controlled switch in series connection. The three resistors of the election circuit are the main devices for dimming that the present invention has a lower cost and superior competition in the market.

### BACKGROUND OF THE INVENTION

1. Field of the Invention

The present invention relates to a dimmer for a discharging lamp and more particularly, to a three-level dimming circuit of a dimmer.

2. Description of the Related Art

Typically, a conventional dimming circuit for a discharging lamp includes a control IC or a complex circuit for variable frequency function to control different power outputs that may change the brightness level of the lamp. However, the control IC and the circuit for variable frequency function are expensive that such dimmers are not popular in the market.

Besides, there are many multilevel dimming IC chips for use with dimmers. However, it still is expensive because of the complex circuit. In conclusion, there is no cheap and well-functional dimming circuit in present market.

### SUMMARY OF THE INVENTION

The primary objective of the present invention is to provide a three-level dimming circuit of a discharging lamp, which completes three-level dimming function by several common electronic devices rather than by chip to lower the cost thereof.

To achieve the objective of the present invention, a three-level dimming circuit for a discharging lamp includes a first contact, a second contact, and a third contact, wherein the first contact is connected to a first contact of an AC power, and both of the second contact and the third contact are connected to a second contact of the AC power. A first full-wave rectification circuit is connected to the first contact and the third contact to transfer the AC power to a DC power. A second full-wave rectification circuit is connected to the first contact and the second contact to transfer the AC power to a DC power. A selection circuit includes a first resistor, a second resistor, a third resistor, and a first electrical controlled switch. The first resistor has opposite ends connected to the second contact and an end of the second resistor, and an opposite end of the second resistor is connected to the third contact. The third resistor has opposite ends connected to a contact between the first resistor and the second resistor and the second full-wave rectification circuit. The first electrical controlled switch has a control terminal connected to a contact between the first resistor and the second resistor and two connection terminals connected to the second full-wave rectification circuit. A half-wave rectification circuit includes a second electrical controlled switch and a third electrical controlled switch in series connection, each of which has a control terminal connected to an oscillation unit and two connection terminals connected to the first full-wave rectification circuit. A discharging lamp is connected to the half-wave rectification circuit.

### BRIEF DESCRIPTION OF THE DRAWINGS

FIG. 1 is a circuit diagram of a preferred embodiment of the present invention;

FIG. 2 is an equivalent circuit diagram of the preferred embodiment of the present invention in a low brightness level;

FIG. 3 is an equivalent circuit diagram of the preferred embodiment of the present invention in a middle brightness level; and

FIG. 4 is an equivalent circuit diagram of the preferred embodiment of the present invention in a high brightness level.

### DETAILED DESCRIPTION OF THE INVENTION

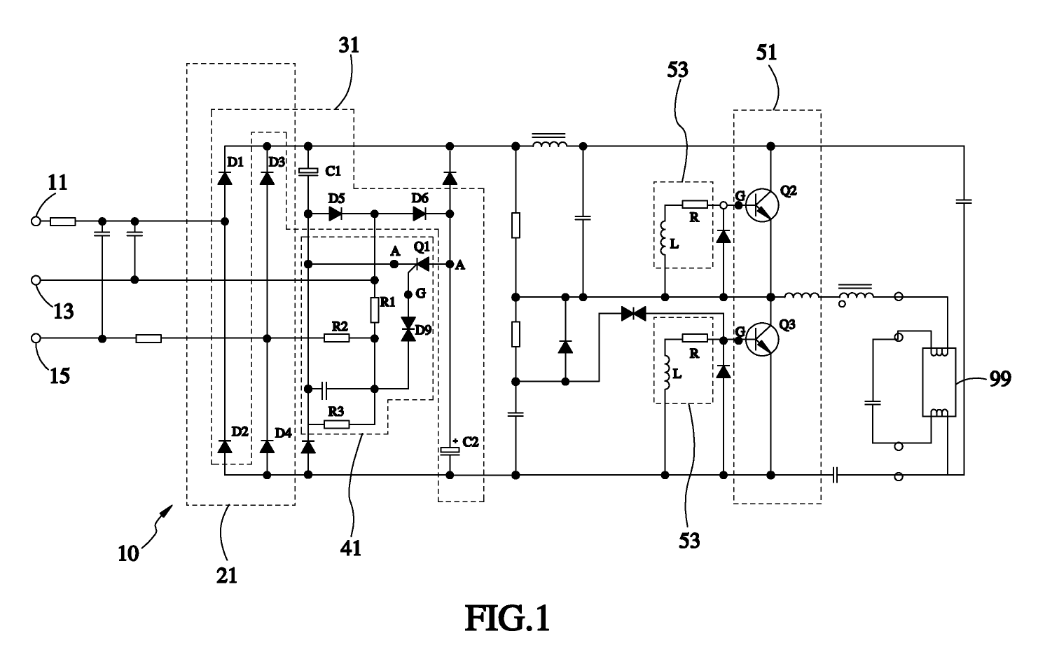

FIG. 1 show a three-level dimming circuit for a discharging lamp, which includes:

A first contact 11, a second contact 13, and a third contact 15 are connected to an AC power, wherein the first contact 11 is connected to a first contact (not shown) of the AC power, and both of the second and third contacts 13 and 15 are connected to a second contact (not shown) of the AC power.

A first full-wave rectification circuit 21 is connected to the first contact 11 and the third contact 15 to transfer the AC power to a DC power. In the present invention, the first full-wave rectification circuit 21 includes a bridge rectifier constructed from a first diode D1, a second diode D2, a third diode D3, and a fourth diode D4. The first contact 11 is connected to a contact between the first and second diodes D1 and D2, and the third contact 15 is connected to a contact between the third and fourth diodes D3 and D4.

A second full-wave rectification circuit 31 is connected to the first contact 11 and the second contact 13 to transfer the AC power to a DC power. In the present invention, the second full-wave rectification circuit 31 includes a bridge rectifier constructed from a fifth diode D5, a sixth diode D6, a seventh diode D7, and an eighth diode D8. The second contact 13 is connected to a contact between the fifth and sixth diodes D5 and D6. The second full-wave rectification circuit 31 further includes a first capacitance C1 and a second capacitance C2. In the present invention, they are electrolytic capacities. The first capacitance C1 has opposite ends connected to the first diode D1 and the fifth diode D5, and the second capacitance C2 has opposite ends connected to the sixth diode D6 and the second diode D2.

A selection circuit 41 includes a first resistor R1, a second resistor R2, a third resistor R3, a first electrical controlled switch Q1, and a diode alternate current switch (DIAC) D9. The first resistor R1 has opposite ends connected to the second contact 13 and an end of the second resistor R2, and the other end of the second resistor R2 is connected to the third contact 15. The third resistor R3 has opposite ends connected to a contact between the first and the second resistors R1 and R2 and the second full-wave rectification circuit 31. The first electrical controlled switch Q1 has a control terminal G and two connection terminals A. The control terminal G is connected to an end of the DIAC D9, and the other end of the DIAC D9 is connected to a contact between the first and second resistors R1 and R2. The connection terminals A are connected to the fifth diode D5 and the first capacitance C1 respectively.

A half-wave rectification circuit 51 includes a second electrical controlled switch Q2 and a third electrical controlled switch Q3 in series connection. Each of the second electrical controlled switch Q2 and the third electrical controlled switch Q3 has a control terminal G and two connection terminals A. Each of the control terminals G of the second and third electrical controlled switch Q2 and Q3 are connected to an oscillation unit 53, which is a RL oscillator including a resistor R and an inductance L in series connection. The half-wave rectification circuit 51 is connected to the first full-wave rectification circuit 21 and the second full-wave rectification circuit 31. A discharging lamp 99 is connected to the half-wave rectification circuit 51.

In operation of the present invention, an AC power is connected thereto, and a multilevel switch (not shown) is connected to the first, second, and third contacts 11, 13, and 15. In the present invention, the multilevel switch has four levels including OFF, low brightness level, middle brightness level, and high brightness level. The first contact 11 and the third contact 15 are connected to the AC power when the switch is switched to the low brightness level, the first contact 11 and the second contact 13 are connected to the AC power when the switch is switched to the middle brightness level, and the first contact 11 and the second contact 13 are connected to the AC power and the first contact 11 and the second contact 13 are connected to the AC power also when the switch is switched to the high brightness level. When the switch is switched to OFF, all of the contacts 11, 13, 15 are disconnected to the AC power. Of course, a discharging lamp 99 is connected to the half-wave rectification circuit 51.

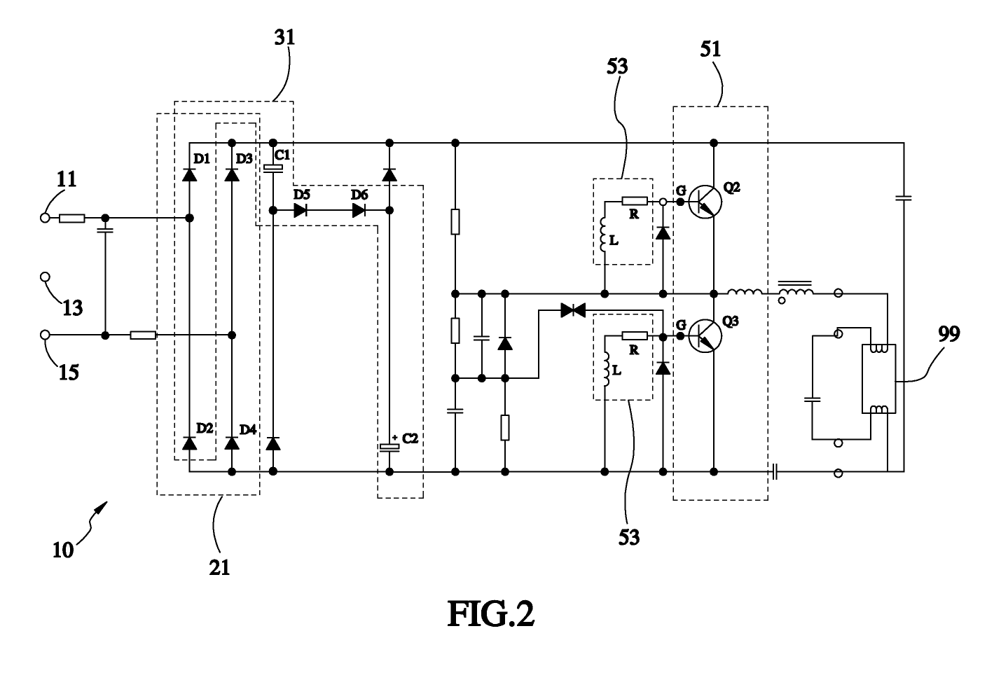

When the switch is switched to the low brightness level, i.e. the first contact 11 and the third contact 15 are connected to the AC power, a potential between the first resistor R1 and the third resistor R3 is insufficient to activate the DIAC D9 that the first electrical controlled switch is turned off. In this condition, the dimming circuit is equivalent to the circuit as shown in FIG. 2. AC current flows through the first full-wave rectification circuit 21 for rectification, and then enters the half-wave rectification circuit 51. The half-wave rectification circuit 51 outputs a lower power to the discharging lamp 99 that the discharging lamp 99 provides a low brightness.

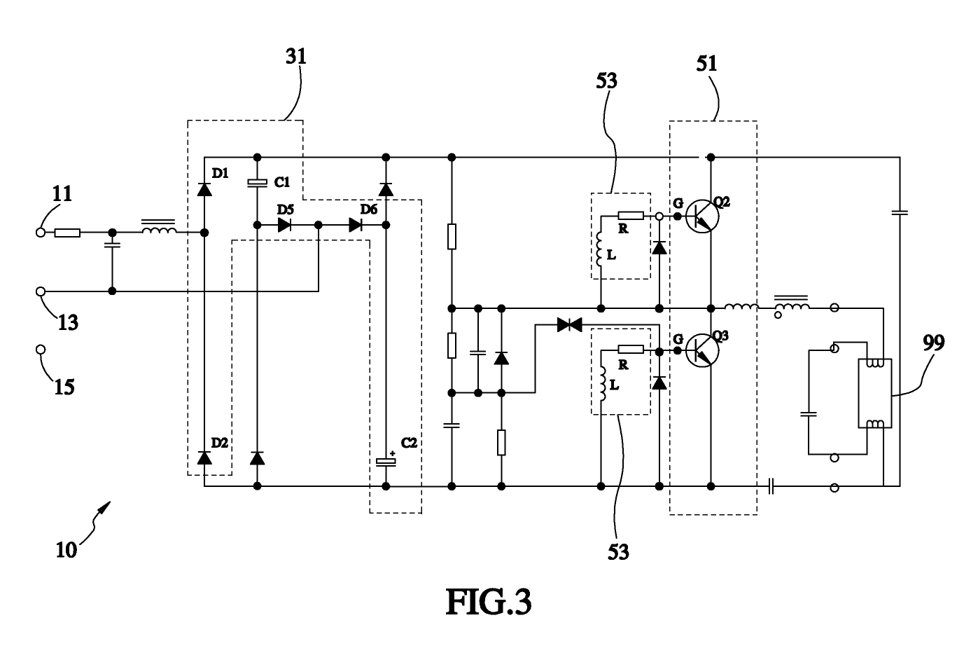

When the switch is switched to the middle brightness level, i.e. the first contact 11 and the second contact 13 are connected to the AC power, a potential between the first resistor R1 and the third resistor R3 is insufficient to activate the DIAC D9 that the first electrical controlled switch is turned off. In this condition, the dimming circuit is equivalent to the circuit as shown in FIG. 3. AC current flows through the second full-wave rectification circuit 31 for rectification, and then enters the half-wave rectification circuit 51. The half-wave rectification circuit 51 outputs a little higher power to the discharging lamp 99 because of a compensative discharge of the first and the second capacitances C1 and C2 that the discharging lamp 99 provides a middle brightness.

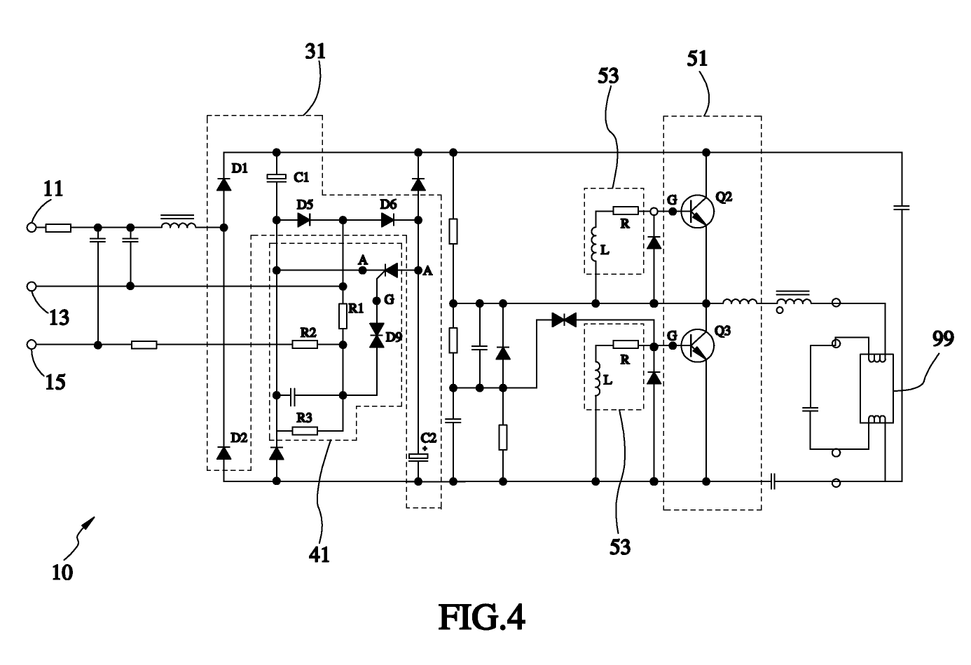

When the switch is switched to the high brightness level, i.e. both of the first and third contacts 11, 15 and the first and second contacts 11, 13 are connected to the AC power, current enters from both of the second contact 13 and the third contact 15 that the first resistor R1 and the second resistor R2 become a parallel connection. An equivalent circuit diagram is shown in FIG. 4. The parallel connected first and second resistors R1 and R2 has a smaller total resistance that a potential is sufficient to activate the DIAC D9 to turn the first electrical controlled switch Q1 on. In such condition, the first full-wave rectification circuit 21 and the second full-wave rectification circuit 31 work with the first capacitor C1 and the second capacitor C2 to become a voltage multiplier/rectifier circuit, wherein both of the third and diode D3 and the fourth diode D4 are not functional so that they are not shown in FIG. 4. The rectified current will enter the half-wave rectification circuit 51 to supply the discharging lamp 99 a higher power that the discharging lamp 99 provides a high brightness.

In conclusion, the present invention provides the first and second full-wave rectification circuits 21 and 31 working with the resistors R1, R2, and R3 of the selection circuit 41 to change the power output. As long as the user selects the predetermined power, the dimming circuit of the present invention may provide the discharging lamp a predetermined power according to the connection of the contacts 11, 13, and 15 and the AC power. In comparison with the conventional device having control IC or complex variable frequency circuit for dimming, the present invention provides three resistors for dimming that will lower a lot of cost and enhance the competition of the products in the market.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A three-level dimming circuit for a discharging lamp, comprising:
a first contact, a second contact, and a third contact, wherein said first contact is connected to a first contact of an AC power, and both of said second contact and said third contact are connected to a second contact of said AC power;
a first full-wave rectification circuit connected to said first contact and said third contact to transfer said AC power to a DC power;
a second full-wave rectification circuit connected to said first contact and said second contact to transfer said AC power to a DC power;
a selection circuit including a first resistor, a second resistor, a third resistor, and a first electrical controlled switch, wherein said first resistor has opposite ends connected to said second contact and an end of said second resistor, and an opposite end of said second resistor is connected to said third contact, and said third resistor has opposite ends connected to a contact between said first resistor and said second resistor and said second full-wave rectification circuit, and said first electrical controlled switch has a control terminal connected to a contact between said first resistor and said second resistor and two connection terminals connected to said second full-wave rectification circuit; and
a half-wave rectification circuit, to which a discharging lamp is connected, including a second electrical controlled switch and a third electrical controlled switch in series connection, each of which has a control terminal connected to an oscillation unit and two connection terminals connected to said first full-wave rectification circuit.

2. The three-level dimming circuit as claimed in claim 1, wherein said first full-wave rectification circuit includes a bridge rectifier constructed from a first diode, a second diode, a third diode, and a fourth diode, and said first contact is connected to a contact between said first diode and said second diode, and said third contact is connected to a contact of said third diode and said fourth diode.

3. The three-level dimming circuit as claimed in claim 2, wherein said second full-wave rectification circuit includes a bridge rectifier constructed from a fifth diode, a sixth diode, a seventh diode, and an eighth diode, and said second contact is connected to a contact between said fifth diode and said sixth diode.

4. The three-level dimming circuit as claimed in claim 3, wherein said second full-wave rectification circuit further includes a first capacitor connected to said first diode and said fifth diode and a second capacitor connected to said sixth diode and said second diode.

5. The three-level dimming circuit as claimed in claim 1, wherein said selection circuit further includes a diode alternate current switch having opposite ends connected to said control terminal of said first electrical controlled switch and a contact between said first resistor and said second resistor.

6. The three-level dimming circuit as claimed in claim 1, wherein each of said oscillation unit is a RL oscillator including a resistor and an inductance in series connection.
